(19) United States
(12) Patent Application Publication
(10) Pub. No.: US 2024/0042374 A1
(43) Pub. Date: Feb. 8, 2024

(54) CARBON DIOXIDE FIXATION METHOD, CARBON DIOXIDE RECOVERY METHOD, CARBON DIOXIDE FIXATION DEVICE AND ENVIRONMENTALLY FRIENDLY INDUSTRIAL FACILITY

(71) Applicant: TOHOKU UNIVERSITY, Sendai-shi, Miyagi (JP)

(72) Inventors: Noriaki WATANABE, Sendai-shi (JP); Jiajie WANG, Sendai-shi (JP); Noriyoshi TSUCHIYA, Sendai-shi (JP)

(73) Assignee: TOHOKU UNIVERSITY, Sendai-shi, Miyagi (JP)

(21) Appl. No.: 18/267,005

(22) PCT Filed: Dec. 7, 2021
(86) PCT No.: PCT/JP2021/045014

§ 371 Date: Jun. 13, 2023

(30) Foreign Application Priority Data
Dec. 25, 2020 (JP) 2020-217738

(51) Int. Cl. B01D 53/14; C01F 11/18; B01D 53/62; B01D 53/78

(52) U.S. Cl. CPC B01D 53/1475; C01F 11/182; B01D 53/1493; B01D 53/62; B01D 53/78; B01D 2257/504; B01D 2251/404; B01D 2251/402

(57) ABSTRACT

A carbon dioxide fixation method, recovery method, fixation device and environmentally friendly industrial facility which can reduce material and facility costs. In aqueous solution formation, alkaline solution including: raw material including metal element which can combine with carbonate ions to form carbonate mineral; and chelating agent is formed. In separation, element is reacted with agent in solution to separate element from raw material as metal ions. In mineral formation, compound which can generate carbonate ions is added into solution to react ions generated from compound with metal ions to form carbonate mineral. In pH lowering, carbon dioxide gas is injected into solution to lower pH thereof to a value of or near pH of solution formed in the solution formation. In repetition, new raw material is added into solution to perform separation to pH lowering steps.

### FIELD OF THE INVENTION

The present invention relates to carbon dioxide fixation methods, carbon dioxide recovery methods, carbon dioxide fixation devices and environmentally friendly industrial facilities.

### DESCRIPTION OF RELATED ART

As global warming has rapidly progressed in recent years, it is required to rapidly reduce carbon dioxide (CO₂) in the atmosphere at a large scale. As one of the powerful methods for reducing carbon dioxide, a method of fixing (mineralizing) carbon dioxide as a poorly water-soluble carbonate mineral has been proposed for the purpose of long-term storage of carbon dioxide (see, for example, Non-Patent Literature 1).

Conventionally, as a carbon dioxide fixation method using mineralization, a so-called pH-swing method (pH-swing process) has been developed in which under low pH conditions (for example, pH<4) using a large amount of acid, rocks and industrial wastes are first dissolved to extract metal ions (Ca²⁺, Mg²⁺), and thereafter, under high pH conditions (for example, pH>9) with the addition of alkali, the extracted metal ions are carbonated to precipitate a carbonate mineral (see, for example, Non-Patent Literature 2).

It has been found by the present inventors and others that as a method with consideration given to a hydrothermal reaction in the ground, a high-concentration ligand NaHCO₃ is utilized as a catalyst to greatly accelerate the dissolution of olivine [(Mg, Fe)₂SiO₄)] under temperature conditions of 225 to 300° C., and thus carbon dioxide can be fixed by the formation of magnesite (MgCO₃) (see, for example. Non-Patent Literature 3).

### CITATION LIST

Non Patent Literature 1: Sandra O. Snabjomsdottir, Bergur Sigfusson. Chiara Marieni, David Goldberg, Sigurdur R. Gislason and Eric H. Oelkers, “Carbon dioxide storage through mineral carbonation”, Nature Reviews Earth & Environment, February 2020, Volume 1, p. 90-102
Non Patent Literature 2: Amin Azdarpour, Mohammad Asadullah, Radzuan Junin, Muhammad Manan, Hossein Hamidi, Ahmad Rafizan Mohamad Daud, “Carbon Dioxide Mineral Carbonation Through pH-swing Process: A Review”, Energy Procedia, 2014, 61, p. 2783-2786
Non Patent Literature 3: Jiajie Wang, Noriaki Watanabe, Atsushi Okamoto, Kengo Nakamura, Takeshi Komai, “Enhanced hydrogen production with carbon storage by olivine alteration in CO2-rich hydrothermal environments”, Journal of CO2 Utilization, 2019, 30, p. 205-213

### SUMMARY OF THE INVENTION

However, the pH swing disclosed in Non-Patent Literature 2 uses a large amount of chemicals for pH adjustment, and thus material costs thereof are disadvantageously increased. Although the method disclosed in Non-Patent Literature 3 opens up a new field of carbon dioxide mineralization by hydrothermal alteration of rocks under alkaline conditions, the temperature at which olivine is dissolved is high, with the result that when the method is performed on a large scale industrially, facility costs may be increased.

The present invention is made in view of the problems as described above, and an object of the present invention is to provide a carbon dioxide fixation method, a carbon dioxide recovery method, a carbon dioxide fixation device and an environmentally friendly industrial facility which can reduce material costs and facility costs.

In order to achieve the object described above, a carbon dioxide fixation method according to the present invention includes: an aqueous solution formation step of forming an alkaline aqueous solution including: a raw material including metal elements that can combine with carbonate ions to form a carbonate mineral; and a chelating agent; a separation step of reacting the metal element with the chelating agent in the aqueous solution to separate the metal element from the raw material as metal ions; a mineral formation step of adding a compound that can generate carbonate ions in the aqueous solution to form a carbonate mineral by reacting the carbonate ions generated from the compound with the metal ions, into the aqueous solution after the separation step; a pH lowering step of injecting carbon dioxide gas into the aqueous solution after the mineral formation step to lower a pH to the pH of the aqueous solution formed in the aqueous solution formation step or a value near that; and a repetition step of adding a new raw material of the same type as the raw material into the aqueous solution after the pH lowering step and performing steps from the separation step to the pH lowering step.

In the carbon dioxide fixation method according to the present invention, the alkaline aqueous solution including the raw material and the chelating agent is first formed in the aqueous solution formation step, and thus in the separation step, the metal element is reacted with the chelating agent, with the result that the metal element can be separated from the raw material as metal ions. In the separation step, the pH of the aqueous solution can be increased by the separation of the metal element.

Then, in the mineral formation step, the compound that can generate carbonate ions in the aqueous solution is added into the aqueous solution after the separation step, and thus the carbonate ions generated from the compound reacts with the metal ions, with the result that a carbonate mineral can be formed. Here, since the pH of the aqueous solution is increased by the separation step, the reaction of the carbonate ions with the metal ions can be accelerated. In this way, carbon dioxide can be fixed as a carbonate mineral.

Then, in the pH lowering step, the carbon dioxide gas is injected into the aqueous solution after the mineral formation step, and thus the pH thereof can be lowered to the value of or a value near the pH of the aqueous solution formed in the aqueous solution formation step, and a carbonate ion concentration in the aqueous solution can be increased. By lowering the pH, a component unrelated to the mineral formation in the mineral formation step or a part thereof can be precipitated in the aqueous solution according to the type of raw material.

Then, in the repetition step, the new raw material is added into the aqueous solution after the pH lowering step, and thus the metal ions generated from the metal element included in the raw material and the metal ions which are not consumed in the first round of the mineral formation step are reacted with the carbonate ions the concentration of which has been increased in the pH lowering step, with the result that it is possible to form a carbonate mineral. In this way, carbon dioxide can be fixed as the carbonate mineral.

The new raw material is added such that a larger number of metal ions than the number consumed in the reaction with the carbonate ions are generated, and thus in the second round of the separation step, the metal element included in the new raw material reacts with the chelating agent left in the aqueous solution, with the result that the metal element can be separated from the raw material as the metal ions. Here, the chelating agent which is fed in the aqueous solution formation step is not consumed in the subsequent steps, and thus the chelating agent can be reused even in the second round of the separation step. As described above, the second round of the separation step can be performed under substantially the same conditions as the first round of the separation step, and the second rounds of the mineral formation step and the pH lowering step can be performed in the same manner as in the first rounds thereof. In this way, even in the second round of the mineral formation step, carbon dioxide can be fixed as the carbonate mineral.

As described above, in the carbon dioxide fixation method according to the present invention, in the first and second rounds of the mineral formation step and at the time of feeding of the new raw material in the repetition step, carbon dioxide can be fixed, with the result that the carbon dioxide fixation method can contribute to the reduction of carbon dioxide which attracts attention in the environmental problem. In the carbon dioxide fixation method according to the present invention, carbon dioxide can be fixed under alkaline conditions, and thus chemicals for pH adjustment as in the pH swing are not needed, with the result that the material cost thereof can be reduced. Since the chelating agent which has been fed once can be reused, the material cost thereof can be reduced. Carbon dioxide can be fixed at a relatively low temperature, and thus facility costs can be reduced.

In the carbon dioxide fixation method according to the present invention, the metal element included in the raw material is not limited as long as the metal element such as calcium, magnesium, iron, copper or manganese can form a carbonate (also called a carbonate mineral), and at least one of the elements described above are preferably included. The raw material is not limited as long as the raw material includes the metal elements, and the raw material preferably includes one or a plurality of relatively easily available materials derived from a silicate mineral, steel slag and waste. The chelating agent is not limited as long as the chelating agent can react with metal ions, and examples of the ligand element of the chelating agent include nitrogen, oxygen, sulfur, phosphorus, arsenic and the like. The chelating agent is a known material, and specifically, the chelating agent is preferably biodegradable GLDA (N,N-Dicarboxymethyl glutamic acid) or EDTA (ethylenediaminetetrancetic acid).

In the carbon dioxide fixation method according to the present invention, the compound which is added in the mineral formation step is not limited as long as the compound such as sodium carbonate, potassium carbonate, lithium carbonate or carbon dioxide can generate carbonate ions in the aqueous solution after the separation step, and the compound preferably includes at least one of these compounds.

In the carbon dioxide fixation method according to the present invention, in order to accelerate the reaction of the carbonate ions with the metal ions in the mineral formation step, the pH of the aqueous solution (aqueous solution used in the mineral formation step) after the separation step is preferably 10 to 14. Since the pH of the aqueous solution is increased in the separation step, the pH of the alkaline aqueous solution formed in the aqueous solution formation step is preferably 8 to 10 and particularly preferably equal to or greater than 8.5 so that the pH of the aqueous solution after the separation step is 10 to 14. In this case, the reaction in the separation step can also be accelerated.

In the carbon dioxide fixation method according to the present invention, in order to accelerate the reaction of the metal element in the raw material with the chelating agent, the separation step is preferably performed at a temperature equal to or greater than 5° C. and equal to or less than 80° C. or may be performed at room temperature. In order to accelerate the reaction of the carbonate ions with the metal ions, the mineral formation step is preferably performed at a temperature of 70° C. to 170° C. The pH lowering step is preferably performed at a temperature equal to or greater than 5° C. and equal to or less than 80° C. or may be performed at room temperature.

In the carbon dioxide fixation method according to the present invention, in the aqueous solution formation step, the aqueous solution is preferably formed by adding the raw material and the chelating agent into water. In the separation step, after the separation of the metal element, a solid component left undissolved in the aqueous solution may be recovered. In the mineral formation step, the carbonate mineral which has been formed is preferably recovered from the aqueous solution after the reaction. In the pH lowering step, a solid component which is precipitated after the pH is lowered may be recovered.

In the carbon dioxide fixation method according to the present invention, the repetition step may be repeated a plurality of times. In this case, at the time of feeding of the new raw material and in the mineral formation step in the repetition step, carbon dioxide can be continuously fixed. The chelating agent fed in the aqueous solution formation step can be repeatedly used in the separation step of the repetition step, and thus material costs can be further reduced.

Preferably, in the carbon dioxide fixation method according to the present invention, carbon dioxide which is used is emitted from an industry with a high environmental burden caused by carbon dioxide emission and is recovered. As a method for separating and recovering carbon dioxide from emission gas, a known method may be adopted. For example, in a “post-combustion recovery method” in which carbon dioxide is recovered after burning of fossil fuels, a “chemical absorption method” in which carbon dioxide is separated by utilization of an aqueous amine solution can be used. In this method, the property of the aqueous amine solution in which carbon dioxide is absorbed in a low temperature state whereas carbon dioxide is discharged at a high temperature is utilized. This method is utilized, and thus carbon dioxide can be separated and recovered.

In the carbon dioxide fixation method according to the present invention, carbon dioxide which is emitted from the industry with a high environmental burden caused by carbon dioxide emission can be utilized to be fixed. For example, in Japan, examples of industries with a high environmental burden based on carbon dioxide emission ratio (2018: International Energy Agency (IEA)) include cement (27%), steel (25%), petrochemicals (14%), pulp and paper (2%), aluminum (2%) and other industries (30%). Thermal power plants which use fossil fuels (such as petroleum, coal and natural gas) as raw materials, steel industries and petrochemical industries are also mentioned as industries with a high environmental burden caused by carbon dioxide emission.

In a carbon dioxide recovery method according to the present invention, carbon dioxide emitted from industries with a high environmental burden caused by carbon dioxide emission is recovered by the carbon dioxide fixation method according to the present invention.

In the carbon dioxide recovery method according to the present invention, the environmental burden caused by these industries can be reduced.

A carbon dioxide fixation device according to the present invention includes: an aqueous solution formation unit which forms an alkaline aqueous solution using: a raw material including a metal element which can combine with carbonate ions to form a carbonate mineral; and a chelating agent; a separation unit which reacts the metal element with the chelating agent in the aqueous solution to separate the metal element from the raw material as metal ions; a mineral formation unit which adds, into the aqueous solution after the separation of the metal ions in the separation unit, a compound that can generate carbonate ions in the aqueous solution to form a carbonate mineral by reacting the carbonate ions generated from the compound with the metal ions; a pH lowering unit which injects carbon dioxide gas into the aqueous solution after the formation of the carbonate mineral in the mineral formation unit to lower the pH thereof to a value of or a value near the pH of the aqueous solution formed in the aqueous solution formation unit; and a raw material addition unit which adds a new raw material of the same type into the aqueous solution whose pH has been lowered in the pH lowering unit, and the aqueous solution into which the new raw material has been added in the raw material addition unit is supplied to the separation unit, and is sequentially moved from the separation unit, to the mineral formation unit and then to the pH lowering unit.

The carbon dioxide fixation device according to the present invention can preferably perform the carbon dioxide fixation method according to the present invention. In the carbon dioxide fixation device and the carbon dioxide fixation method according to the present invention, it is possible to provide a carbonate mineral in which carbon dioxide is fixed. For example, the carbon dioxide fixation device according to the present invention is preferably used when carbon dioxide emitted in the industry with a high environmental burden caused by carbon dioxide emission is fixed, and is preferably incorporated as a part of an environmentally friendly industrial facility. In other words, an environmentally friendly industrial facility according to the present invention includes the carbon dioxide fixation device according to the present invention.

According to the present invention, it is possible to provide a carbon dioxide fixation method, a carbon dioxide recovery method, a carbon dioxide fixation device and an environmentally friendly industrial facility which can reduce material costs and facility costs.

### BRIEF DESCRIPTION OF THE DRAWINGS

FIG. 1(a) is an example of a flowchart showing the flow of individual steps, and FIG. 1(b) is a graph showing the pH and the temperature of an aqueous solution in each of the steps in a carbon dioxide fixation method according to an embodiment of the present invention.

FIG. 2 are diagrams of unit operations performed in an aqueous solution formation step and a separation step in the carbon dioxide fixation method according to the embodiment of the present invention, FIG. 2(a) is an example of a perspective view showing a state where the aqueous solution is stirred to cause a separation reaction and FIG. 2(b) is an example of a perspective view showing an aqueous solution (upper diagram) filtered after the separation reaction and a solid component (lower diagram).

FIG. 3 shows changes in the concentration of Ca with time when the separation reaction shown in FIG. 2(a) is performed in the carbon dioxide fixation method according to the embodiment of the present invention, FIG. 3(a) is a graph showing the pH dependence of the aqueous solution, FIG. 3(b) is a graph showing the temperature dependence of the aqueous solution, FIG. 3(c) is a graph showing the dependence of the amount of the raw material of CaSiO₃ fed and FIG. 3(d) is a graph showing the dependence of a chelating agent on the concentration of GLDA.

FIG. 4(a) is an example of a perspective view showing a state where Na₂CO₃ is added into the aqueous solution to cause a reaction, and FIG. 4(b) shows a perspective view (upper diagram) of the aqueous solution filtered after the reaction and an electron micrograph (lower diagram) of a solid component in a mineral formation step of the carbon dioxide fixation method according to the embodiment of the present invention.

FIG. 5(a) is an example of a graph showing the residual ratio (Residual Ca and Si ratio) of Ca and Si in the aqueous solution at each temperature after the elapse of 70 minutes and FIG. 5(b) is an example of a graph showing changes in the residual ratio of Ca in each concentration of Na₂CO₃ with time when the temperature of the aqueous solution is 80° C. as the results of the reaction shown in FIG. 4(a) in the carbon dioxide fixation method according to the embodiment of the present invention.

FIG. 6 shows a pH lowering step in the carbon dioxide fixation method according to the embodiment of the present invention, FIG. 6(a) is an example of a perspective view showing a state where carbon dioxide gas (CO₂ gas) is injected into the aqueous solution and FIG. 6(b) shows a perspective view (upper diagram) of the aqueous solution filtered after the injection of the carbon dioxide gas for 5 minutes and an electron micrograph (lower diagram) of a solid component.

FIG. 7 is an example of a graph showing a relationship between the pH of the aqueous solution and the concentration of Si when the carbon dioxide gas is injected in FIG. 6(a) in the carbon dioxide fixation method according to the embodiment of the present invention.

FIG. 8 shows the separation step of a repetition step in the carbon dioxide fixation method according to the embodiment of the present invention, FIG. 8(a) is an example of a perspective view showing a state where the aqueous solution into which the raw material has been added is stirred to cause a separation reaction and FIG. 8(b) is an example of a perspective view showing the aqueous solution (upper diagram) filtered after the separation reaction and a solid component (lower diagram).

FIG. 9 shows the mineral formation step of the repetition step in the carbon dioxide fixation method according to the embodiment of the present invention, FIG. 9(a) is an example of a perspective view showing a state where Na₂CO₃ is added into the aqueous solution to cause a reaction and FIG. 8(b) is an example of a perspective view showing the aqueous solution (upper diagram) filtered after the reaction and a solid component (lower diagram).

FIG. 10 shows the aqueous solution formation step and the repetition step in the carbon dioxide fixation method according to the embodiment of the present invention and is a flowchart showing the amounts of components in individual steps when 100 kg of the raw material of CaSiO₃ is fed.

### DETAILED DESCRIPTION OF THE INVENTION

Embodiments of the present invention will be described below based on drawings, Example and the like.

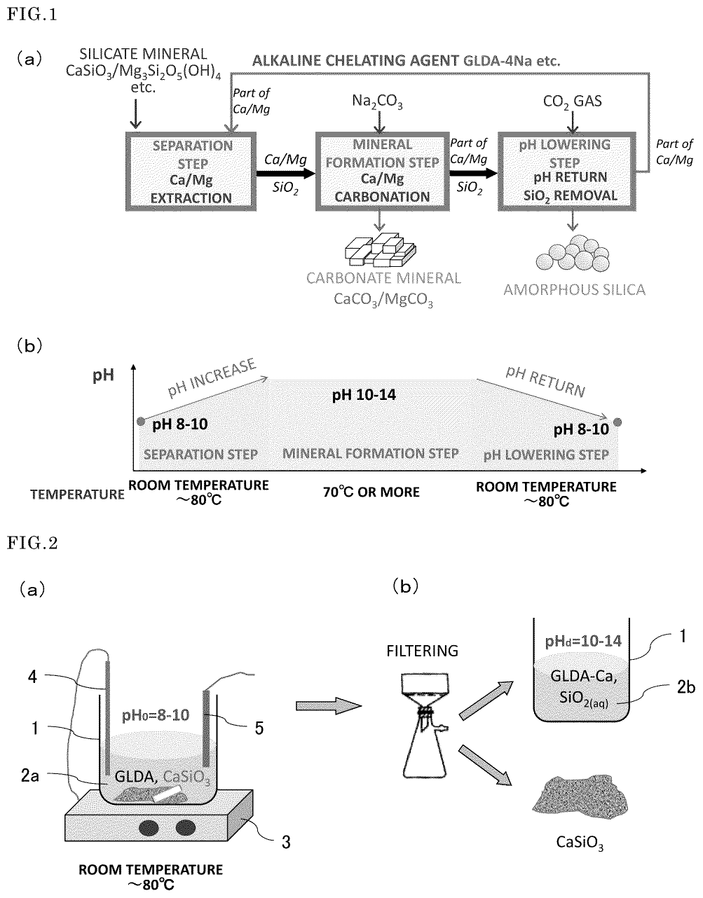

FIG. 1 shows a carbon dioxide fixation method according to an embodiment of the present invention.

As shown in FIG. 1, the carbon dioxide fixation method according to the embodiment of the present invention includes an aqueous solution formation step, a separation step, a mineral formation step, a pH lowering step and a repetition step.

In the carbon dioxide fixation method according to the embodiment of the present invention, as the aqueous solution formation step, a raw material including a metal element and a chelating agent are first added into water to form an alkaline aqueous solution having a pH of 8 to 10. The temperature of the aqueous solution is set in a range equal to or greater than room temperature and equal to or less than 80° C. In a specific example, the chelating agent is added into water to form the aqueous solution having a pH of 8 to 10, the temperature of the aqueous solution is set in the range equal to or greater than room temperature and equal to or less than 80° C. and thereafter the raw material is added into the aqueous solution.

In the aqueous solution formation step, the metal element included in the raw material is formed of an element which can combine with carbonate ions to form a carbonate mineral, and examples thereof include calcium, magnesium, iron, copper, manganese and the like. The raw material includes the metal elements described above, and is, for example, a silicate mineral, steel slag, waste or the like which is relatively easily available. The chelating agent includes a material which can react with metal ions, and is, for example, biodegradable GLDA-4Na, EDTA-4Na or the like. In a specific example shown in FIG. 1, the metal element is Ca or Mg, and the raw material is CaSiO₃ or Mg₃Si₂O₅(OH)₄ which is a silicate mineral.

When the aqueous solution is formed in the aqueous solution formation step, in the separation step, the metal element included in the raw material reacts with the chelating agent so as to be separated as metal ions in the aqueous solution. By the separation of the metal element, the pH of the aqueous solution is increased, and thus the pH of the aqueous solution after the separation step is 10 to 14. In the separation step, after the separation of the metal element, a solid component which is left without being dissolved in the aqueous solution may be recovered.

Then, after the separation step, as the mineral formation step, the temperature of the aqueous solution (having a pH of 10 to 14) after the separation step is increased to 70° C. or more, and a compound which can generate carbonate ions in the aqueous solution is added. In this way, the carbonate ions which are generated from the compound added into the aqueous solution reacts with the metal ions, and thus a carbonate mineral can be formed. Consequently, carbon dioxide can be fixed as the carbonate mineral. In the mineral formation step, the formed carbonate mineral is preferably recovered from the aqueous solution after the reaction. The recovered carbonate mineral can be effectively utilized. In the mineral formation step, the pH of the aqueous solution hardly changes.

The compound which is added into the aqueous solution in the mineral formation step can generate carbonate ions in the aqueous solution after the separation step, and examples thereof include sodium carbonate, potassium carbonate, lithium carbonate, carbon dioxide and the like. In the specific example shown in FIG. 1, the compound is sodium carbonate (Na₂CO₃), and can carbonate Ca or Mg in the raw material to form CaCO₃ or MgCO₃ which is a carbonate mineral.

Then, after the mineral formation step, as the pH lowering step, the temperature of the aqueous solution after the mineral formation step is set in the range equal to or greater than room temperature and equal to or less than 80° C., and carbon dioxide gas is injected to lower the pH thereof to a value of or a value near the pH of the aqueous solution formed in the aqueous solution formation step. Specifically, the pH is lowered to a value of 8 to 10, and is returned to the original value. In this way, the concentration of carbonate ions in the aqueous solution is increased. By lowering the pH, a component unrelated to the mineral formation in the mineral formation step or a part thereof can be precipitated in the aqueous solution. In the pH lowering step, a solid component which is precipitated may be recovered from the aqueous solution the pH of which has been lowered. The recovered solid component can be effectively utilized. In the specific example shown in FIG. 1, silica (SiO₂) which is a part of the raw material can be precipitated as amorphous silica.

Then, after the pH lowering step, as the repetition step, a new raw material of the same type is first added into the aqueous solution after the pH lowering step. Here, metal ions which are generated from a metal element included in the new raw material or the metal ions which are not consumed in the first round of the mineral formation step react with the carbonate ions, and thus a carbonate mineral can be formed. In this way, carbon dioxide can be fixed as the carbonate mineral. In the repetition step, the carbonate mineral formed here is preferably recovered from the aqueous solution after the reaction. The recovered carbonate mineral can be effectively utilized.

In the repetition step, the new raw material is added such that a larger number of metal ions than the number consumed in the reaction with the carbonate ions are generated, and thus steps from the separation step to the pH lowering step are performed again. In the second round of the separation step, the metal element included in the new raw material reacts with the chelating agent left in the aqueous solution, and thus the metal element can be separated from the raw material as metal ions. The chelating agent which is fed in the aqueous solution formation step is not consumed in the subsequent steps, and thus the chelating agent can be reused even in the second round of the separation step. As described above, the second round of the separation step can be performed under substantially the same conditions as the first round of the separation step, and the second rounds of the mineral formation step and the pH lowering step can be performed in the same manner as in the first rounds thereof. In this way, even in the second round of the mineral formation step, carbon dioxide can be fixed as the carbonate mineral.

As described above, in the carbon dioxide fixation method according to the embodiment of the present invention, in the first and second rounds of the mineral formation step and at the time of feeding of the new raw material in the repetition step, carbon dioxide can be fixed, with the result that the carbon dioxide fixation method can contribute to the reduction of carbon dioxide to be emitted. In the carbon dioxide fixation method according to the embodiment of the present invention, carbon dioxide can be fixed under alkaline conditions, and thus chemicals for pH adjustment as in the pH swing are not needed, with the result that the material cost thereof can be reduced. Since the chelating agent which has been fed once can be reused, the material cost thereof can be reduced. Carbon dioxide can be fixed at a relatively low temperature, and thus facility costs can be reduced.

In the carbon dioxide fixation method according to the embodiment of the present invention, the repetition step may be repeated a plurality of times. In this case, at the time of feeding of the new raw material and in the mineral formation step in the repetition step, carbon dioxide can be continuously fixed. The chelating agent fed in the aqueous solution formation step can be repeatedly used in the separation step of the repetition step, and thus material costs can be further reduced.

### Example 1

As a raw material. CaSiO₃ (made by FUJIFILM Wako Pure Chemical Corporation) was used, as a chelating agent, GLDA-4Na (N,N-Dicarboxymethyl glutamic acid, tetrasodium salt made by Tokyo Chemical Industry Co., Ltd.) was used and experiments on the carbon dioxide fixation method according to the embodiment of the present invention were performed. Experiments on an aqueous solution formation step and a separation step were first performed. In the experiments, as shown in FIG. 2(a), GLDA-4Na was added into 100 ml of water in a beaker 1 to form an aqueous solution 2a, CaSiO₃ was fed into the formed aqueous solution 2a and was stirred, as shown in FIG. 2(b), after a predetermined time had elapsed, the aqueous solution was filtered and thus undissolved CaSiO₃ was removed. In the experiments, the beaker 1 storing the aqueous solution 2a was placed on a stirrer 3 with a heater, and the temperature and the pH of the aqueous solution during the experiments were respectively measured with a temperature sensor 4 and a pH sensor 5.

The experiments were performed as shown in Table 1 under conditions in which the pH (pH₀) of the aqueous solution 2a, the temperature of the aqueous solution 2a, the amount of CaSiO₃ fed and the concentration of GLDA-4Na serving as parameters were variously changed. In the experiments, in order to check a state where Ca serving as a metal element was separated from the raw material, the concentration of Ca (Ca ions) in an aqueous solution 2b which had been filtered and the like in experiments Nos. 1 to 12 shown in Table 1 were measured. In the following description, all the Ca in the aqueous solution indicates Ca ions.

TABLE 1

| | | | | | After elapse of 20 minutes | | | | | |
|---|---|---|---|---|---|---|---|---|---|---|
| At time of formation of aqueous solution | | | | | | | | | Ca extraction | |
| | GLDA-4Na | Ca silicate | Temp. | | | Ca | Si | Ca/Si | rate | Ca/GLDA |
| Experiments | (M) | (M) | (° C.) | pH₀ | pH_{d} | (mM) | (mM) | (molar ratio) | (%) | (molar ratio) |
| 1 | 0 | 0.4 | 50 | 10.0 | 12.5 | 7.82 | 0.39 | 20.0 | 1.96 | — |
| 2 | 0 | 0.4 | 50 | 13.5 | 13.6 | 2.15 | 0.03 | 86.0 | 0.54 | — |
| 3 | 0.3 | 0.4 | 50 | 8.0 | 9.8 | 174.60 | 20.19 | 8.6 | 43.65 | 0.58 |
| 4 | 0.3 | 0.4 | 50 | 9.0 | 11.9 | 151.52 | 69.25 | 2.2 | 37.88 | 0.51 |
| 5 | 0.3 | 0.4 | 50 | 10.0 | 13.4 | 130.48 | 68.46 | 1.9 | 32.62 | 0.43 |
| 6 | 0.3 | 0.4 | 80 | 10.0 | 12.9 | 144.20 | 45.95 | 2.2 | 33.39 | 0.48 |
| 7 | 0.3 | 0.4 | 25 | 10.0 | 12.9 | 126.22 | 56.82 | 2.2 | 31.55 | 0.42 |
| 8 (without | 0.3 | 0.4 | 25 | 10.0 | 13.8 | 121.03 | 57.43 | 2.1 | 30.26 | 0.40 |
| stirring) | | | | | | | | | | |
| 9 | 0.3 | 0.3 | 50 | 10.0 | 13.4 | 104.73 | 50.68 | 2.1 | 34.91 | 0.35 |
| 10 | 0.3 | 0.2 | 50 | 10.0 | 12.8 | 72.78 | 40.64 | 1.8 | 36.39 | 0.24 |
| 11 | 0.6 | 0.4 | 50 | 10.0 | 13.4 | 129.48 | 61.93 | 2.1 | 32.27 | 0.22 |
| 12 | 0.15 | 0.4 | 50 | 10.0 | 13.1 | 122.48 | 66.04 | 1.9 | 30.63 | 0.82 |

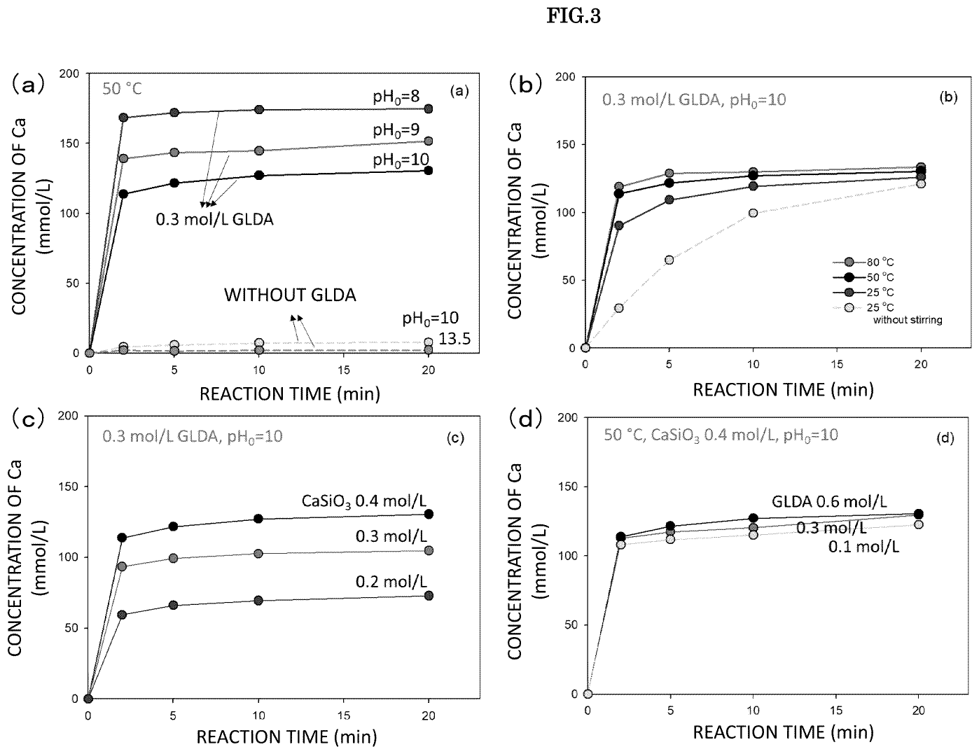

In experiments Nos. 1 to 12 of Table 1, changes in the concentration of Ca in each of the aqueous solutions with time until the elapse of 20 minutes after the feeding of CaSiO₃ into the aqueous solution 2a are shown in FIGS. 3(a) to 3(d). The pH (pH_{d}), the concentration of Ca, the concentration of Si, the separation rate of Ca (Ca extraction rate) and the like in each of the aqueous solutions after the elapse of 20 minutes are shown in Table 1. FIG. 3(a) shows the results of experiments Nos. 1 to 5 in Table 1. FIG. 3(b) shows the results of experiments Nos. 5 to 8 in Table 1, FIG. 3(c) shows the results of experiments Nos. 5, 9 and 10 in Table 1 and FIG. 3(d) shows the results of experiments Nos. 5, 11 and 12 in Table 1. In experiment No. 8, stirring was not performed (without stirring).

As shown in FIGS. 3(a) to 3(d), it has been confirmed that the separation reaction of Ca caused by the chelating agent was almost completed within 20 minutes. As shown in FIG. 3(a), it has been confirmed that as the pH was decreased, the extracted amount of Ca (separated amount) was increased. As shown in FIG. 3(b), it has been confirmed that as the temperature of the aqueous solution was increased, the separation rate of Ca was increased but the separation reaction of Ca was almost completed in 20 minutes regardless of the temperature and whether stirring was performed, and thus the extracted amount of Ca was almost the same. As shown in FIG. 3(c), it has been confirmed that the extracted amount of Ca was substantially proportional to the amount of raw material. As shown in FIG. 3(d), it has been confirmed that the concentration of the chelating agent did not significantly affect the extracted amount of Ca.

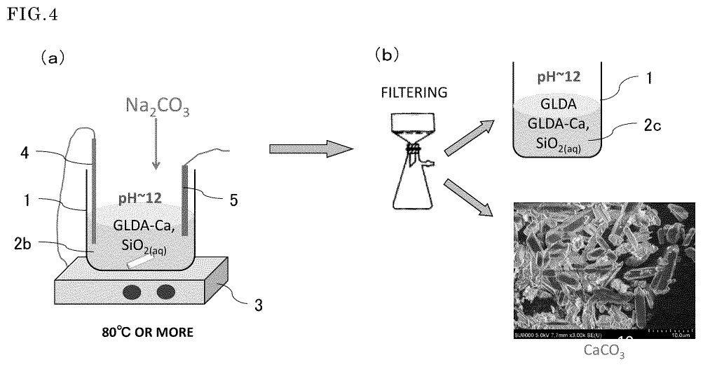

Then, experiments on a mineral formation step were performed. The aqueous solution 2b (pH of 11.9) in which the aqueous solution after the elapse of 20 minutes in experiment No. 4 of Table 1 had been filtered was used, as shown in FIG. 4(a), sodium carbonate (Na₂CO₃) was added into the aqueous solution 2b and was stirred, the aqueous solution was filtered after a predetermined time had elapsed as shown in FIG. 4(b) and thus a solid component was removed. In the experiments, the amount of Ca in an aqueous solution 2c which had been filtered was measured, and the residual ratio of Ca after the addition of Na₂CO₃ was determined. The experiments were performed at each of the temperatures of the aqueous solution which were 60° C., 80° C., 120° C. and 160° C. and at each of the concentrations of Na₂CO₃ which were 0.3 mol/L and 0.6 mol/L. As a container for storing the aqueous solution, the beaker 1 was used when the temperature of the aqueous solution was 60′C and 80° C., and a pressure container was used when the temperature of the aqueous solution was 120° C. and 160° C.

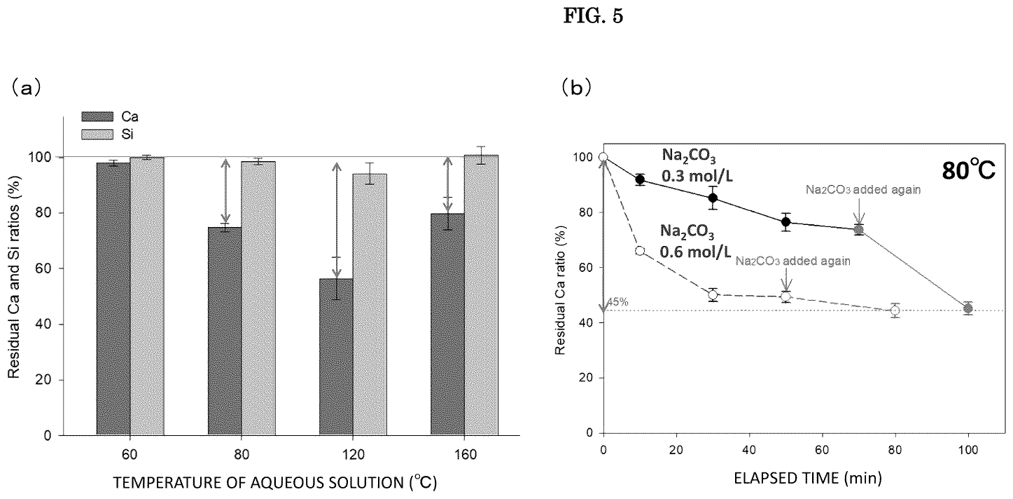

The residual ratios of Ca (Residual Ca ratios) in the aqueous solution at the temperatures after the elapse of 70 minute after the addition of Na₂CO₃ when the concentration of Na₂CO₃ was set to 0.3 mol/L are shown in FIG. 5(a). In FIG. 5(a), for comparison, the residual ratios of Si (Residual Si ratios) are also shown. Changes in the residual ratio of Ca at the concentrations of Na₂CO₃ with time when the temperature of the aqueous solution was 80° C. are shown in FIG. 5(b).

As shown in FIG. 5(a), it has been confirmed that at temperatures of 80° C. to 160° C., the amount of Si hardly changed whereas the amount of Ca was significantly reduced. As shown in FIG. 5(b), it has been confirmed that when the temperature of the aqueous solution was 80° C., the amount of Ca was reduced with time. It has been confirmed that as the amount of Na₂CO₃ added was increased, the reduction rate of Ca was increased. It has been confirmed that even when the reduction rate of Ca was decreased, if Na₂CO₃ was added, the reduction rate of Ca was increased again, and the maximum amount of Ca reduction was about 45%.

As shown in FIG. 4(b), it has been confirmed that since the solid component obtained by filtering was aragonite (CaCO₃) which is a carbonate mineral, Ca was carbonated to reduce the amount of Ca in the aqueous solution. The purity of the aragonite obtained was equal to or greater than 90%. In FIG. 5(a), the reduction amount of Ca was maximized when the temperature of the aqueous solution was 120° C. Since a pressure container or the like is required at a temperature of 100′C or more and the size of the device increases facility costs, the mineral formation step is preferably performed at a temperature of less than 100° C. in practical use.

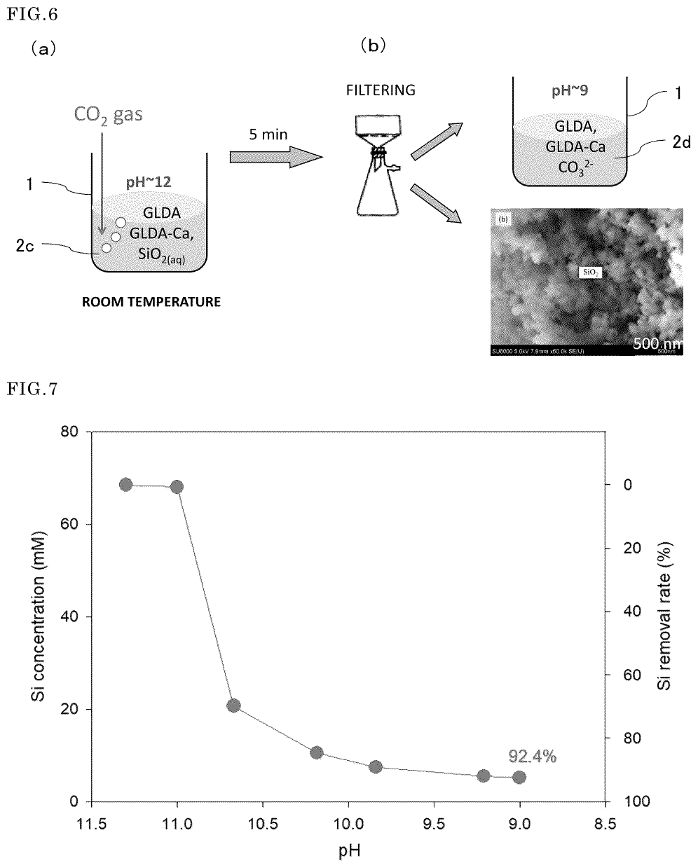

Then, experiments on a pH lowering step were performed. The amount of Ca was reduced to about 45%, the aqueous solution 2c shown in FIG. 4(b) which had been filtered was used, as shown in FIG. 6(a), carbon dioxide gas (CO₂ gas) was injected into the aqueous solution 2c for 5 minutes and thereafter as shown in FIG. 6(b), the aqueous solution was filtered and thus a solid component was removed. In the experiments, the temperature of the aqueous solution 2c was set to room temperature, and the pH and the Si concentration of the aqueous solution during the injection of the carbon dioxide gas were measured.

A relationship between the pH and the Si concentration which were measured is shown in FIG. 7. As shown in FIG. 7, it has been confirmed that as carbonate ions were formed by the injection of the carbon dioxide gas and thus the pH of the aqueous solution was lowered, the Si concentration was lowered. It has been confirmed that the injection of carbon dioxide for 5 minutes lowered the pH of the aqueous solution to 9. As shown in FIG. 6(b), since the solid component obtained by filtering was amorphous silica (SiO₂), it has been confirmed that the amorphous silica was formed by lowering the pH to remove Si in the aqueous solution. As shown in FIG. 7, it has been confirmed that if the pH of the aqueous solution is lowered to 10 or less, the removal rate of Si (Si removal rate) increases to about 90% or more and Si is able to be mostly removed.

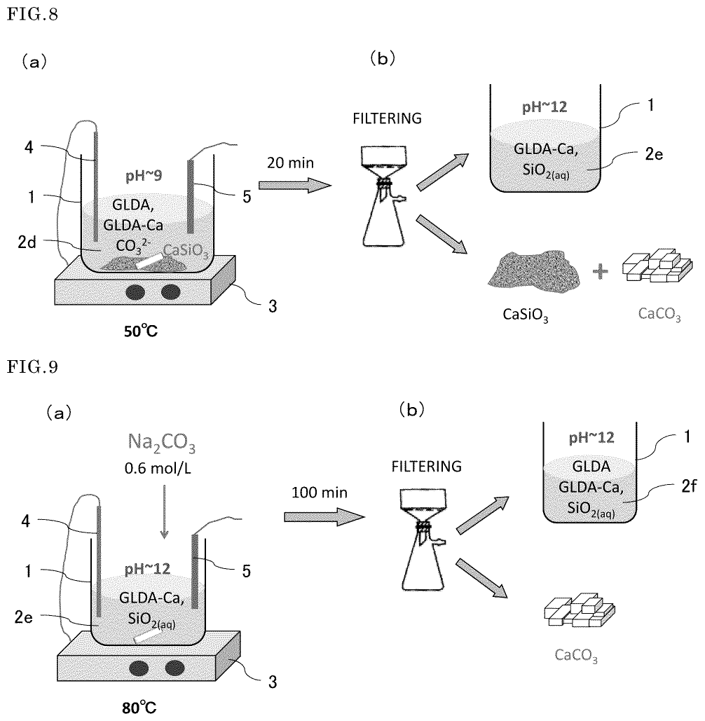

Then, experiments on the repetition step were performed. The pH was lowered to 9, an aqueous solution 2d shown in FIG. 6(b) which had been filtered was used, as shown in FIG. 8(a), the raw material of CaSiO₃ was added into the aqueous solution 2d again and was stirred, the aqueous solution was filtered after 20 minutes of stirring as shown in FIG. 8(b) and thus a solid component was removed. In the experiments, the temperature of the aqueous solution 2d was set to 50° C., and the amount of CaSiO₃ fed was set to 0.4 mol/L. When the pH of an aqueous solution 2e which had been filtered was measured, the pH was about 12. When the solid component obtained by filtering was checked, the presence of undissolved CaSiO₃ and aragonite (CaCO₃) which was a carbonate mineral was able to be confirmed.

Consequently, it has been confirmed that Ca included in the newly added CaSiCO₃ and Ca which was not consumed in the first round of the mineral formation step reacts with the carbonate ions the concentration of which had been increased in the pH lowering step, and thus CaCO₃ is formed. It has also been confirmed that since the pH was increased. Ca included in the newly added CaSiO₃ reacted with the chelating agent left in the aqueous solution and thus Ca was extracted from CaSiO₃. It has been confirmed that the aqueous solution 2e obtained after filtering in the second round of the separation step shown in FIG. 8(b) was substantially the same as the aqueous solution 2b obtained after filtering in the first round of the separation step shown in FIG. 2(b).

Then, the aqueous solution 2e shown in FIG. 8(b) which had been filtered was used, as shown in FIG. 9(a), sodium carbonate (Na₂CO₃) was added into the aqueous solution 2e and was stirred, the aqueous solution was filtered after the elapse of 100 minutes as shown in FIG. 9(b) and thus a solid component was removed. In the experiments, the temperature of the aqueous solution 2e was set to 80° C., and the concentration of Na₂CO₃ was set to 0.6 mol/L. When the pH of an aqueous solution 2f which had been filtered was measured, the pH was about 12. When the solid component obtained by filtering was checked, the solid component was aragonite (CaCO₃) which is a carbonate mineral. The purity of the aragonite obtained was equal to or greater than 90%. It has been confirmed that the aqueous solution 2f obtained after filtering in the second round of the mineral formation step shown in FIG. 9(b) was substantially the same as the aqueous solution 2c obtained after filtering in the first round of the mineral formation step shown in FIG. 4(b).

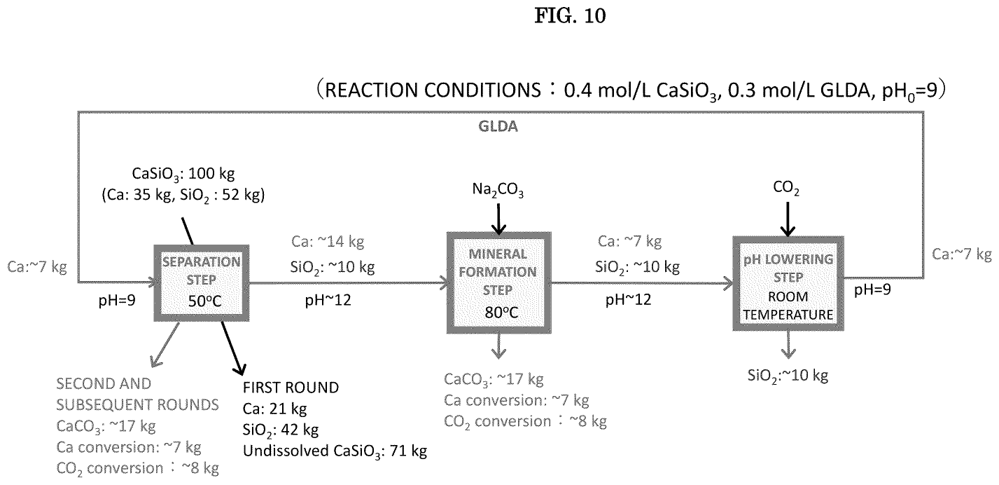

It has been mentioned from the experiments on the repetition step shown in FIGS. 8 and 9 that the second rounds of the separation step, the mineral formation step and the pH lowering step were able to be performed in the same manner as in the first rounds thereof. Based on the results of the experiments which have been described above, the mass balance at each step when 100 kg of the raw material of CaSiO₃ was added in the aqueous solution formation step and the repetition step were calculated and shown in FIG. 10. As shown in FIG. 10, under conditions of the pHs, the temperatures of the aqueous solutions and the concentrations shown in the figure, in the first round of the mineral formation step, about 8 kg of carbon dioxide can be fixed, and in the second rounds of the separation step and the mineral formation step in the repetition step, about 8 kg of carbon dioxide can be individually fixed. Hence, for example, in the repetition step, the separation step, the mineral formation step and the pH lowering step are repeated, and thus about 16 kg of carbon dioxide can be fixed from 100 kg of CaSiO₃ in each repetition step.

A carbon dioxide fixation device according to an embodiment of the present invention can easily be designed and produced by applying the carbon dioxide fixation method according to the embodiment of the present invention. Specifically, the carbon dioxide fixation device according to the embodiment of the present invention includes an aqueous solution formation unit, a separation unit, a mineral formation unit, a pH lowering unit and a raw material addition unit. The aqueous solution formation unit forms an alkaline aqueous solution including: a raw material including a metal element which can combine with carbonate ions to form a carbonate mineral; and a chelating agent, and can perform the aqueous solution formation step in the carbon dioxide fixation method according to the embodiment of the present invention. The separation unit reacts the metal element with the chelating agent in the aqueous solution to separate the metal element from the raw material as metal ions, and can perform the separation step in the carbon dioxide fixation method according to the embodiment of the present invention. The mineral formation unit adds, into the aqueous solution after the separation of the metal ions in the separation unit, a compound which can generate carbonate ions in the aqueous solution to react the carbonate ions generated from the compound with the metal ions so as to form a carbonate mineral, and can perform the mineral formation step in the carbon dioxide fixation method according to the embodiment of the present invention. The pH lowering unit injects carbon dioxide gas into the aqueous solution after the formation of the carbonate mineral in the mineral formation unit to lower the pH thereof to a value of or a value near the pH of the aqueous solution formed in the aqueous solution formation unit, and can perform the pH lowering step in the carbon dioxide fixation method according to the embodiment of the present invention. The raw material addition unit adds a new raw material of the same type as the raw material used in the aqueous solution formation unit into the aqueous solution the pH of which has been lowered in the pH lowering unit. Furthermore, in the carbon dioxide fixation device according to the embodiment of the present invention, the aqueous solution into which the new raw material has been added in the raw material addition unit is supplied to the separation unit, and is sequentially moved from the separation unit, to the mineral formation unit and then to the pH lowering unit, and can perform, together with the raw material addition unit, the repetition step in the carbon dioxide fixation method according to the embodiment of the present invention. In this way, the carbon dioxide fixation method and the carbon dioxide fixation device according to the embodiments of the present invention can provide a carbonate mineral in which carbon dioxide is fixed.

The carbon dioxide fixation device according to the embodiment of the present invention can fix carbon dioxide emitted from an industry with a high environmental burden caused by carbon dioxide emission. The carbon dioxide fixation device according to the embodiment of the present invention can be incorporated as an environmentally friendly industrial facility and a part thereof which fix carbon dioxide emitted in an industry with a high environmental burden caused by carbon dioxide emission. In other words, the environmentally friendly industrial facility according to an embodiment of the present invention includes the carbon dioxide fixation device according to the embodiment of the present invention.

In a carbon dioxide recovery method according to an embodiment of the present invention, carbon dioxide emitted in an industry with a high environmental burden caused by carbon dioxide emission is recovered by the carbon dioxide fixation method according to the embodiment of the present invention. In this way, in the carbon dioxide recovery method according to the embodiment of the present invention, it is possible to reduce environmental burdens caused by these industries.

### REFERENCE SIGNS LIST

1: Beaker
2a, 2b, 2c, 2d, 2e, 2f: Aqueous solution
3: Stirrer with a heater
4: Temperature sensor
5: pH sensor

1. A carbon dioxide fixation method comprising:
an aqueous solution formation step of forming an alkaline aqueous solution including: a raw material including a metal element that can combine with carbonate ions to form a carbonate mineral; and a chelating agent;
a separation step of reacting the metal element with the chelating agent in the aqueous solution to separate the metal element from the raw material as metal ions;
a mineral formation step of adding, into the aqueous solution after the separation step, a compound that can generate carbonate ions in the aqueous solution to form a carbonate mineral by reacting the carbonate ions generated from the compound with the metal ions;
a pH lowering step of injecting carbon dioxide gas into the aqueous solution after the mineral formation step to lower a pH thereof to a value of or a value near a pH of the aqueous solution formed in the aqueous solution formation step; and
a repetition step of adding a new raw material of the same type as the raw material first added into the aqueous solution after the pH lowering step and performing steps from the separation step to the pH lowering step.

2. The carbon dioxide fixation method according to claim 1,
wherein the repetition step is repeated a plurality of times.

3. The carbon dioxide fixation method according to claim 1,
wherein the raw material includes, as the metal element, at least one of calcium, magnesium, iron, copper and manganese, and includes one or a plurality of a silicate mineral, steel slag and waste.

4. The carbon dioxide fixation method according to claim 1,
wherein the compound includes at least one of sodium carbonate, potassium carbonate, lithium carbonate and carbon dioxide.

5. The carbon dioxide fixation method according to claim 1,
wherein the pH of the aqueous solution formed in the aqueous solution formation step is 8 to 10,
in the separation step, the metal element is reacted with the chelating agent at a temperature equal to or greater than 5° C. and equal to or less than 80° C. and
in the mineral formation step, the carbonate ions are reacted with the metal ions at a temperature of 70° C. to 170° C.

6. The carbon dioxide fixation method according to claim 1,
wherein in the separation step, a solid component is recovered from the aqueous solution after the metal element is separated from the raw material,
in the mineral formation step, after the carbonate mineral is formed, the carbonate mineral is recovered and
in the pH lowering step, after the pH is lowered, a solid component is recovered.

7. The carbon dioxide fixation method according to claim 1,
wherein the aqueous solution to be formed in the aqueous solution formation step is formed by adding the raw material and the chelating agent into water.

8. A carbon dioxide recovery method,
wherein carbon dioxide emitted from an industry with a high environmental burden caused by carbon dioxide emission is recovered by the carbon dioxide fixation method according to claim 1.

9. A carbon dioxide fixation device comprising:
an aqueous solution formation unit that forms an alkaline aqueous solution including: a raw material including a metal element that can combine with carbonate ions to form a carbonate mineral; and a chelating agent;
a separation unit that reacts the metal element with the chelating agent in the aqueous solution to separate the metal element from the raw material as metal ions;
a mineral formation unit that adds, into the aqueous solution after the separation of the metal ions in the separation unit, a compound that can generate carbonate ions in the aqueous solution to form a carbonate mineral by reacting the carbonate ions generated from the compound with the metal ions;
a pH lowering unit that injects carbon dioxide gas into the aqueous solution after the formation of the carbonate mineral in the mineral formation unit to lower a pH thereof to a value of or a value near a pH of the aqueous solution formed in the aqueous solution formation unit; and
a raw material addition unit that adds a new raw material of the same type as the raw material first added into the aqueous solution whose pH has been lowered in the pH lowering unit,
wherein the aqueous solution into which the new raw material has been added in the raw material addition unit is supplied to the separation unit, and is sequentially moved from the separation unit, to the mineral formation unit and then to the pH lowering unit.

10. An environmentally friendly industrial facility comprising:
the carbon dioxide fixation device according to claim 9.
